(19) United States
(12) Patent Application Publication
(10) Pub. No.: US 2008/0120471 A1
(43) Pub. Date: May 22, 2008

(54) METHOD AND APPARATUS FOR LEAST-RECENTLY-USED REPLACEMENT OF A BLOCK FRAME IN AN ELECTRONIC MEMORY DEVICE

(75) Inventor: Florian Blaschegg, Vienna (AT)

Correspondence Address: SCHNECK & SCHNECK, P.O. BOX 2-E, SAN JOSE, CA, 95109-0005, US

(73) Assignee: ON DEMAND MICROELECTRONICS, Vienna (AT)

(21) Appl. No.: 11/935,970

(22) Filed: Nov. 6, 2007

Related U.S. Application Data
(60) Provisional application No. 60/864,435, filed on Nov. 6, 2006.

(51) Int. Cl. G06F 12/00

(52) U.S. Cl. 711/136; 711/128

(57) ABSTRACT

A method and apparatus for replacement in a least-recently-used strategies is disclosed. An exemplary embodiment of the replacement strategy presented herein is a replacement strategy for set associative caches. The method and apparatus stores a priority level to determine which block frame is to be selected for replacement. Due to its simplicity, the disclosed approach and apparatus enables small implementations and is easily scalable. Consequently, the present method and apparatus is highly desirable for implementations of area critical applications.

### CROSS-REFERENCE TO RELATED APPLICATION

This application claims priority from U.S. Provisional Patent Application Ser. No. 60/864,435 entitled “Method and Apparatus for Least Recently Used Replacement” filed Nov. 6, 2006 which is hereby incorporated by reference in its entirety.

### TECHNICAL FIELD

The invention relates in general to microprocessors, and in particular to a replacement strategies in least-recently-used (LRU) approaches such as LRU caches.

### BACKGROUND OF THE INVENTION

Many different processor architectures are known in the art. State-of-the-art processors typically make use of caches to improve memory access. Cache is the name given to the first level of memory hierarchy encountered after a processing unit. The processing unit can be a central processing unit (CPU). However, since the concept of improving performance by means of a cache mechanism is very popular, the term cache is generally applied whenever buffering is employed to locally store commonly reused items. Other examples of caches are file caches or name caches. For example, a cache is used to buffer items of memories on lower levels. Such memories on lower levels can be a main memory or even a disk storage.

FIG. 1E shows, in simplified form, a low level memory 50 which has 32 blocks 51. For example, block 12 of the low level memory 50 should be cached in a block frame of a cache. FIG. 1A to FIG. 1D show in simplified form four options of a cache 10, 20, 30, 40 which each has eight block frames 11. The block frame 11 can be called a cache-line. FIG. 1A shows a fully associative cache 10 which allows block 12 of the low level memory 50 to go into any of the eight block frames of the fully associative cache 10. FIG. 1B shows a direct mapped cache 20 where block 12 of the low level memory 50 can only be placed into block frame 4. The number 4 is the result of a modulo operation (12 modulo 8). FIG. 1C shows a set associative cache 30 where each set comprises 2 block frames 11. The set associative cache 30 has some of both features of the fully associative cache 10 and the direct mapped cache 20. Block 12 of the low level memory 50 can go in any block frame 11 of set 0 of the set associative cache 30. The number of the set (0) in FIG. 1C where block 12 goes to can be determined by a modulo operation as well: 12 modulo 4 results to 0.

FIG. 1D again shows a second set associative cache 40 where, however, each set comprises 4 block frames 11. In this case, block 12 of the low level memory 50 can go in any block frame 11 of set 0 of the second set associative cache 40. The number of the set (0) in FIG. 1C where the block 12 goes to can be determined by a modulo operation as well: 12 modulo 2 results now to 0.

Real caches have thousands of block frames and real memories can have billions of blocks. The set associative cache 30 of FIG. 1C has four sets with two block frames per set and is frequently termed a two-way set associative cache. The second set associative cache 40 of FIG. 1D has two sets with four block frames per set and is called four-way set associative cache.

Set associative caches are commonly used in processor architectures. It should be noted in FIG. 1C and FIG. 1D that the modulo operation can be used to determine the number of the set in a cache into which a block of a memory can go. However, to select a block frame within a set different strategies exist. Those strategies have to be applied when blocks are written to the cache. Different mechanisms are applied in case a block is read from a cache and the cache must provide functionality to find the correct block in the set.

A common and simple strategy to find a block frame within a set when blocks are written to a cache is the first-in first-out (FIFO) approach. The block that was written first—the oldest block—is overwritten when a new block goes into the set. The following example is offered as illustrative for further understanding of this concept. A write pointer can mark the position of the block frame within a set where the next block goes to. Once the block frame has been written the pointer is incremented. The pointer is reset to the beginning of the set when it exceeds the end of the set. Such an approach is easy to implement. However this approach is not an optimal strategy as used block frames are overwritten regardless how often they are queried.

A better strategy can be the least-frequently-used (LFU) approach. The block frame of a set which has been queried the least is overwritten. However, the LFU approach is not adequate when block frames with a high number of queries in a set have not been used for a long time. The LFU approach can be very expensive and, hence, requires additional concepts to allow block frames with a high number of queries to be selected for writing.

Another good strategy is the least-recently-used (LRU) approach. The block frame of a set is selected for writing which is the least recently been used. This approach is easier to implement than the LFU approach and, hence, applied more often. The strategy of selecting the block frame that is to be overwritten next is called a replacement strategy. A new kind of apparatus and method to implement LRU replacement strategies is within a scope of the present invention.

Other replacement strategies are, for example, “random.” In these replacement strategies, the block frame to be replaced is randomly selected, or “clock” which uses a sequential approach that queries a status bit to determine the block to be selected for replacement.

Caches are just one example, however, a very striking example for LRU replacement strategies. Caches have to be very fast and logic elements to implement a replacement strategy in a set have to be small in order to allow small areas of the whole cache. Therefore, there is a need for a high-performance and a small implementation size for LRU replacement strategies that provides a very simple circuit and mechanism to select the block frame to be replaced.

### SUMMARY OF THE INVENTION

In an exemplary embodiment, the present invention is an electronic system to implement a replacement strategy. The system includes a set of N blocks and a set of N priority modules. Each of the set of N blocks is capable of storing at least one value and each of the N priority modules is electrically coupled to a select one of the set of N blocks. Each of the set of N priority modules includes a priority level register configured to store a priority level value where the priority level is an integer within a range of 0 to N−1, an incrementor configured to generate a next higher priority level value, an equal comparator configured to compare the priority level value with a reference value and generate an equal signal when the priority level value and the reference value are equal, the reference value being an integer from 0 to N−1. Each of the set of N priority modules further includes a second comparator configured to compare the priority level value with the reference value and generate a second signal when the priority level value is greater than the reference value and a logic circuit configured to load the priority level register, the logic circuit further configured to be responsive to the equal signal and the second signal.

In another exemplary embodiment, the present invention is a method of reading a block from a set of N blocks in a data processing environment. The method includes storing a select one of a plurality of priority level values in each of a set of N priority modules, determining whether a selected block in the set of N blocks is available using an address of the block, determining a current priority level value where the current priority level value is a priority level of the selected block to be read, reading the selected block, resetting the current priority level to zero, and incrementing each priority level of a set of N priority level registers to a next higher priority level which are lower than a reference value.

In another exemplary embodiment, the present invention is a method of replacing a current block in a set of N blocks with a new block in the set of N blocks in a data processing environment. The method includes storing one of a plurality of priority level values in each of a plurality of priority modules, determining whether the current block has a priority level value of N−1, overwriting the current block with the new block, and resetting the priority level value assigned to the current block to zero, and incrementing each priority level of the set of N priority level registers to a next higher priority level except for the priority level assigned to the current block.

### BRIEF DESCRIPTION OF THE DRAWINGS

The appended drawings illustrate exemplary embodiments of the present invention only and, therefore, may not be considered as limiting a scope of the present invention.

FIGS. 1A-1E show in simplified form several prior art options of a cache to store a block of low level memory.

FIG. 2 an exemplary embodiment of a priority module of the present invention and includes a register which stores a priority level and logic to reset, to increase, or to hold the priority level.

FIG. 3 shows, in simplified form, an exemplary embodiment of an architecture of the present invention illustrating an implementation of a set of a four-way set associative cache which uses the priority module 100 of FIG. 2.

FIG. 4 shows, in simplified form, an exemplary method of the present invention to read a block from the set associative cache.

FIG. 5 shows, in simplified form, an exemplary method of the present invention to write a block to the set associative cache.

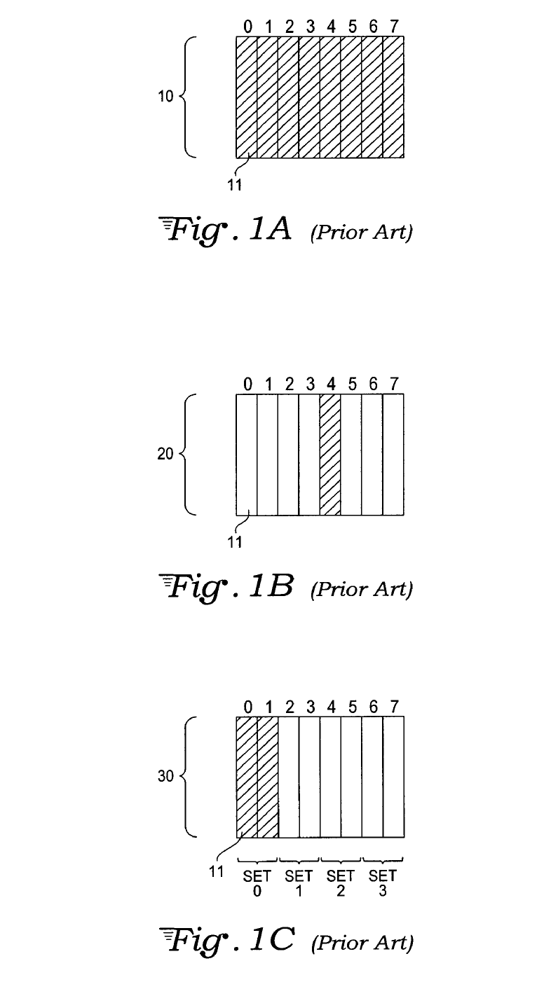

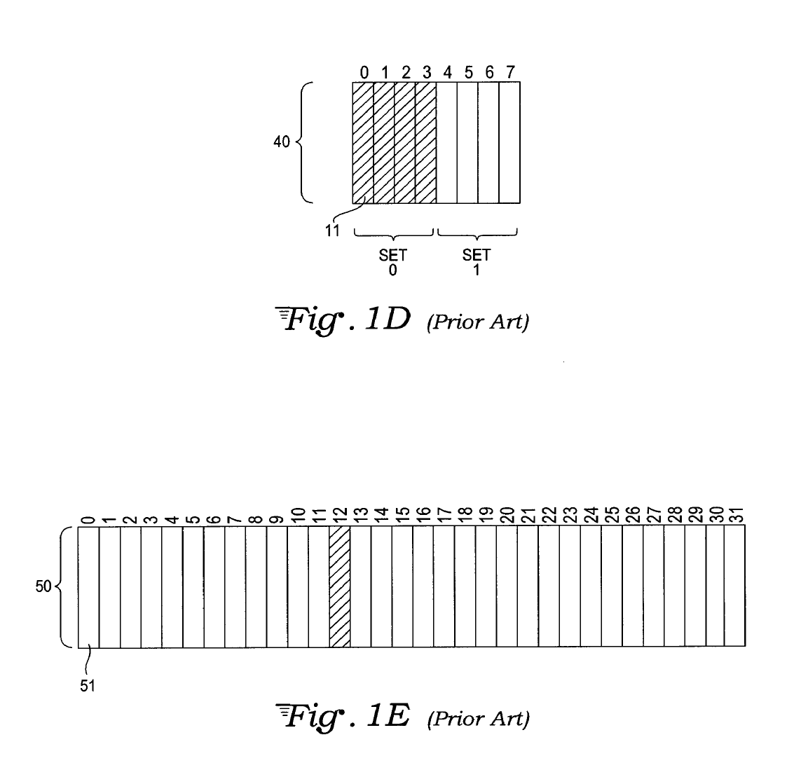

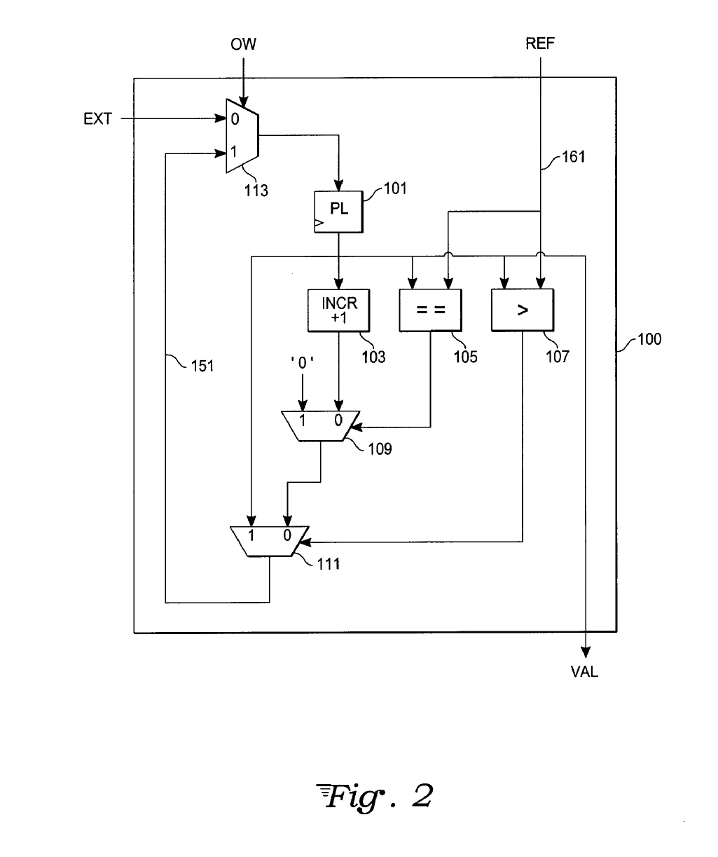

### DETAILED DESCRIPTION

A method and apparatus for replacement strategies is disclosed herein. An exemplary embodiment of the replacement strategy presented in this disclosure is a replacement strategy in set associative caches. However, the apparatus and method presented herein can be used in various applications where easy implementations for replacement strategies are desired. The method and apparatus stores a priority level to determine which block frame is to be selected for replacement. A priority level of N−1 marks a block frame to be replaced, a priority level of 0 is assigned to a block frame when the block is queried. The entire logic is small and allows implementation in area critical applications.

With reference to FIG. 2, an exemplary schematic diagram of a priority module 100 stores a priority level (PL) value in a PL register 101. The PL value can take on any integer value in a range of 0 to N−1 where N is the number of block frames that can be stored in a set of a set associative cache. The value 0 represents the lowest priority and the value N−1 represents the highest priority. An incrementor 103 increments the PL value and, hence, calculates the next higher priority by adding one. The so calculated next higher PL value of the incrementor 103, the PL value stored in the PL register 101, and the value zero are passed to a first multiplexer 109 and a second multiplexer 111 which determine the value, carried on a second multiplexer output line 151, to be stored next in the PL register 101—i.e., a subsequent PL value. The subsequent PL value on the second multiplexer output line 151 depends on a relation between the PL value and a reference value on a reference value line 161. The next PL value on the second multiplexer output line 151 is set to zero if the PL value is equal to the reference value on the reference value line 161, it is the next higher PL value if the PL value stored in the PL register 101 is lower than the reference value on the reference value line 161. Otherwise, it is set to the PL value (i.e., it holds the value).

Using a third multiplexer 113, a signal OW can be used to decide whether the PL register 101 is loaded with the subsequent PL value on the second multiplexer output line 151 or with a reset value “ext” applied to the priority module 100.

When a plurality of priority modules 100 are used in a circuit to implement a replacement strategy, each of the plurality of modules 100 hold different values at each clock cycle and, hence, have to be reset with different values at reset time.

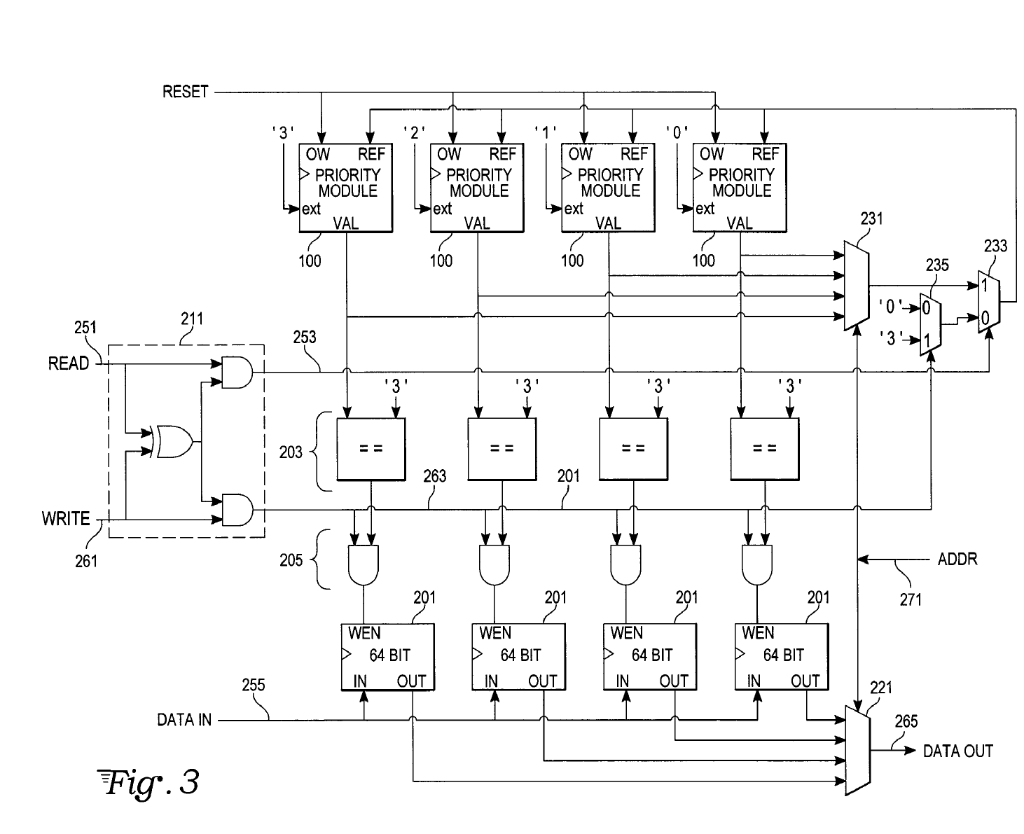

FIG. 3 shows an exemplary embodiment in which four priority modules 100 are used to implement a set of a four-way set associative cache. Each of a plurality of memories 201 store a single block frame—a single cache line. The plurality of memories 201 are controlled by the VAL output signals of the plurality of priority modules 100. As described above, each of the plurality of priority modules 100 store a different PL value where the PL values range from 0 to N−1. That is, in the exemplary embodiment of FIG. 3, the values range from 0 to 3. The priority module 100 that stores the maximum value N−1 (3 in case of FIG. 3) marks exactly that memory 201 which holds the block which has been queried the least recently, i.e., one of a plurality of comparators 203 signals true to its succeeding one of the plurality of AND gates 205.

Each of the plurality of memories 201 can hold a block. When a certain block has to be written to a select one of the plurality of memories 201 in the current set, the input data (the block) are applied to each of the plurality of memories 201 in parallel and a write signal 261 is set to true. A logic circuit 211 prevents both a read and a write signal being applied simultaneously and sets the write signal 263. The set write signal 263 then enables that one of the plurality of AND gates 205 which receives a true signal from one of the plurality of comparators 203 as described above. The enabled AND gate of the plurality of AND gates 205 sends a write enable signal (wen) to the corresponding one of the plurality of memories 201. Thus, when a write signal 261 is set the input data 255 are stored in one of the plurality of memories 201 that is marked by the corresponding one of the plurality of priority modules 100. A priority module 100 marks its corresponding memory 201 when the PL value which is stored in that priority module 100 has the maximum PL value, which is 3 in the case of the embodiment shown in FIG. 3.

When a block has to be read from the implementation of a set of a four-way set associative cache shown in FIG. 3, data are read from one of the plurality of memories 201. A read address 271 is applied and a read signal 251 is set. A data out multiplexer 221 selects the desired one of the plurality of memories 201 and outputs the block data. The logic circuit 211 again prevents that both a read and a write signal are applied simultaneously and sets the read signal 253. However, it is to note that other embodiments of the present invention may allow simultaneous read and write access. The read signal 253 in turn switches a PL multiplexer 233 which applies the PL value of that priority module 100 that is selected by a priority module output select multiplexer 231 with the address 271 to each of the priority modules 100 as a reference value.

The applied reference value causes the priority module 100 that exactly has that PL value to reset its PL value to zero and the remaining priority modules 100 which have lower PL values to increase their PL values. Thus, the logic shown in FIG. 3 memorizes which of the plurality of memories 201 has been queried recently using the plurality of priority modules 100. The most recently queried (or written) block has the PL 0, the next has 1 and so forth. The least recently queried block has the highest PL value, which is N−1.

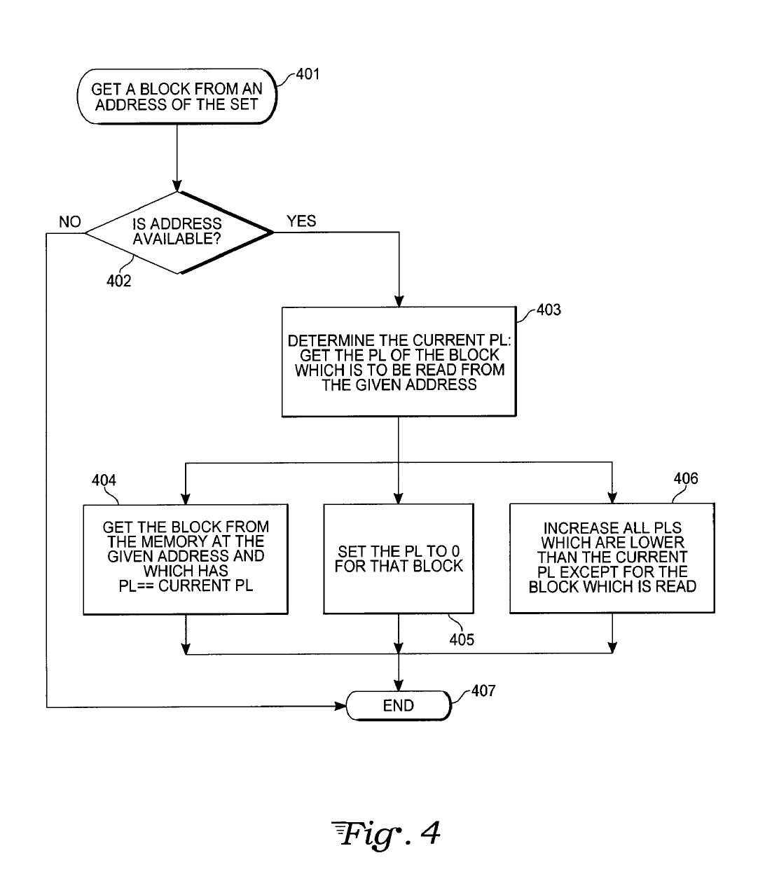

With reference to FIG. 4, an exemplary method to read a block from a set of set associative cache is illustrated. In step 401, an address is used to access and read a block from the set of the cache. According to step 402, a check is performed whether a valid block is available for the given address. If no block is available for the address, the method is aborted. Otherwise, the current PL value is determined in step 403. The current PL value is the PL value of that block which is read from the given address.

Steps 404, 405, and 406 can be performed in parallel or sequentially in that order. In step 404, the block is read from the memory with the given address. According to step 405, the PL value of the block which is read is set to 0. Finally, step 406 illustrates that the PL values of those blocks are increased, which are lower than the current PL value. Steps 405 and 406 ensure that the PL values are set properly before a subsequent block is read or written.

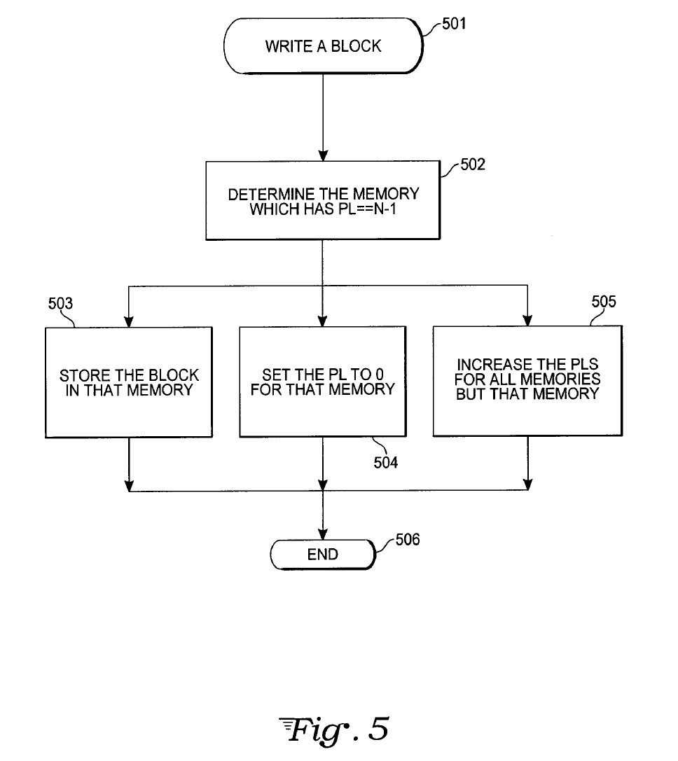

Referring now to FIG. 5, an exemplary method to write a block, beginning with step 501, in a certain set of a set associative cache is illustrated. In step 502, a determination is made as to which memory has a PLURALITY value equal to N−1. Steps 503, 504, and 505 may be performed in parallel or sequentially in that order. As illustrated in step 503, the block is stored in the memory which has a PL value equal to N−1. According to step 504, the PL value for that block is set to zero. The PL values of all remaining blocks are increased as illustrated in step 505. Steps 504 and 505 ensure that the PL values are set properly before a subsequent block is be read or written.

What is claimed is:

1. An electronic system to implement a replacement strategy, the system comprising:
a set of N blocks, each of the set of N blocks capable of storing at least one value; and
a set of N priority modules, each of the N priority modules being electrically coupled to a select one of the set of N blocks, each of the set of N priority modules including:
a priority level register configured to store a priority level value, the priority level being an integer within a range of 0 to N−1;
an incrementor configured to generate a next higher priority level value;
an equal comparator configured to compare the priority level value with a reference value and generate an equal signal when the priority level value and the reference value are equal, the reference value being an integer from 0 to N−1;
a second comparator configured to compare the priority level value with the reference value and generate a second signal when the priority level value is greater than the reference value; and
a logic circuit configured to load the priority level register, the logic circuit further configured to be responsive to the equal signal and the second signal.

2. The electronic system of claim 1 further comprising the logic circuit being configured to:
load the priority level register with a zero when the priority level value and the reference value are equal;
load the priority level register with a next higher priority level value when the priority level value is lower than the reference value; and
load the priority level register with the priority level value when the priority level is higher than the reference value.

3. The electronic system of claim 1 wherein the priority level register has log(N−1)+1 bits.

4. The electronic system of claim 1 wherein the logic includes a means to reset the priority level register to a certain reset value.

5. The electronic system of claim 1 wherein the set of N blocks forms a set of an N-associative cache.

6. A method of reading a block from a set of N blocks in a data processing environment, the method comprising:
storing a select one of a plurality of priority level values in each of a set of N priority modules;
determining whether a selected block in the set of N blocks is available using an address of the block;
determining a current priority level value,
the current priority level value being a priority level of the selected block to be read;
reading the selected block;
resetting the current priority level to zero; and
incrementing each priority level of a set of N priority level registers to a next higher priority level which are lower than a reference value.

7. The method of claim 6 further comprising selecting the priority level register to have log(N−1)+1 bits.

8. The method of claim 6 wherein the set of N blocks forms a set of a N-associative cache.

9. The method of claim 6 further comprising:
passing each of the plurality of priority level values of the plurality of priority modules to a logic circuit;
selecting one of the priority levels passed to the logic circuit;
selecting a reference value from a set of possible values, the set of possible values comprising the integers of “0,” “N−1,” and the selected priority level; and
applying the reference value to each of the plurality of priority modules.

10. The method of claim 9 wherein the “0” is selected when a set of a selected cache is not accessed, the value of “N−1” is selected when a block is written to the set of the selected cache, and the selected priority level is selected when a block is read from the set of the selected cache.

11. A method of replacing a current block in a set of N blocks with a new block in the set of N blocks in a data processing environment, the method comprising:
storing one of a plurality of priority level values in each of a plurality of priority modules;
determining whether the current block has a priority level value of N−1;
overwriting the current block with the new block; and
resetting the priority level value assigned to the current block to zero;
incrementing each priority level of the set of N priority level registers to a next higher priority level except for the priority level assigned to the current block.

12. The method of claim 11 further comprising selecting the priority level register to have log(N−1)+1 bits.

13. The method of claim 11 wherein the set of N blocks forms a set of a N-associative cache.

14. The method of claim 11 further comprising:
passing each of the plurality of priority level values of the plurality of priority modules to a logic circuit;
selecting one of the priority levels passed to the logic circuit;
selecting a reference value from a set of possible values, the set of possible values comprising the integers of “0,” “N−1,” and the selected priority level; and
applying the reference value to each of the plurality of priority modules.

15. The method of claim 14 wherein the “0” is selected when a set of a selected cache is not accessed, the value of “N−1” is selected when a block is written to the set of the selected cache, and the selected priority level is selected when a block is read from the set of the selected cache.
